(19) United States
(12) Patent Application Publication
(10) Pub. No.: US 2014/0375471 A1
(43) Pub. Date: Dec. 25, 2014

(54) Field Device

(71) Applicant: Endress + Hauser Flowtec AG, Reinach (CH)

(72) Inventors: Bjorn Larsson, Birsfelden (CH); Ivo Bragger, Reinach (CH)

(21) Appl. No.: 14/311,712

(22) Filed: Jun. 23, 2014

(30) Foreign Application Priority Data
Jun. 24, 2013 (CH) 10 2013 106 578.3

(51) Int. Cl. G08C 19/00

(52) U.S. Cl. CPC G08C 19/00
USPC 340/870.01

(57) ABSTRACT

A field device having a sensor for ascertaining a measurement signal and a transmitter for converting the measurement signal into a first output signal; wherein an output unit is arranged in or on the transmitter for output of the first output signal, wherein the transmitter has two or more positioning locations for the output unit.

### FIELD DEVICE

The present invention relates to a field device as defined in the preamble of claim 1.

Well known are field devices having a transmitter and one or more sensors. A display is integrated into the transmitter. Corresponding field devices have long been produced and sold by the assignee.

Usually, the displays applied in such case are relatively tablet-like compared with the dimensions of the transmitter.

In the case of maintenance tasks and in the case of verifying conversion of the measurement data ascertained by the sensor, the problem results that, by implementing a compact transmitter construction, the tablet-shaped display covers a number of assemblies and hinders their accessibility for maintenance and verification purposes.

According to the invention, a field device includes a sensor for producing a measurement signal and a transmitter for conversion of the measurement signal into a first output signal; wherein in or on the transmitter an output unit is arranged for output of the first output signal and wherein the transmitter has two or more positioning locations for the output unit.

This construction enables accessibility of the individual segments of the transmitter, for example, for maintenance tasks, without the dimensioning of the output unit becoming disadvantageous. A corresponding output unit is especially a display, but it can, however, also be a signal transmission unit or some other device for issuing an output signal. It need not, thus, absolutely be an optical output, but, instead, can be also only an outgoing transmission signal, which can be read on a cell phone, computer or tablet-PC. The said output unit, in such case, does not need to be held in the hand during the verification or maintenance, but, instead, can be parked, respectively secured, using the positioning locations on or in the transmitter.

Advantageous variants of the invention form subject matter of the dependent claims.

It is advantageous when the transmitter has in the region of one of the positioning locations one or more coupling elements, on or in which the output unit is releasably positionable. An especially well manageable positioning can be enabled by means of the aforementioned coupling variants. These coupling variants can be provided in a special embodiment in the form of plug connection elements.

It is advantageous when the field device has at least two operating modes; wherein a first operating mode assures a standard operation and a second operating mode as a verification mode enables verification of the conversion of the measurement signal into a second output signal by the transmitter; wherein, for performing the verification mode, an electronics connector is provided, whose accessibility in the standard operation is made difficult and whose accessibility is facilitated in the verification mode; wherein the output unit for performing the standard operation mode is positionable in or on a first positioning location of the positioning locations and wherein the output unit is positionable in or on a second positioning location for performing the verification mode. While the service technician, thus, concentrates on the verification and the read-out of the second output signals, he can check this with the first output signal on a display—as output unit.

The electronics connector can especially provide a 4-20 mA electrical current output. Here, the second output signal can be tapped.

It is especially advantageous when the output unit is embodied as a display for display of at least one row of characters or numbers and has a longitudinal axis, which extends centrally through the row of said characters or numbers, wherein this longitudinal axis of the display device extends at a first positioning location parallel to the longitudinal axis of the display device at a second positioning location. The longitudinal axis of the display apparatus can extend at a first positioning location parallel to the longitudinal axis of the display device at all additional positioning locations. In this way, the read off direction of the display is always the same and is only vertically or laterally displaced.

A field device can in an further advantageous embodiment additionally have at least two operating modes, wherein one operating mode assures a standard operation and one operating mode a feeding-in or reading-out of data into or out of a memory unit of the field device, wherein for performing the feeding-in or reading-out of the data a data transfer connector is provided, whose accessibility is made difficult in the standard operation and whose accessibility is facilitated in the verification mode, wherein the output unit for performing the standard operation mode is positionable in or on a first positioning location of the positioning locations and wherein the output unit is positionable in or on a second positioning location of the positioning locations for performing the feeding-in or reading-out of the data.

According to the invention, the output unit is embodied in such a manner that it displays an output signal during the feeding-in or reading-out of data and/or during the verification mode.

The present invention will now be explained in greater detail based on a selected example of an embodiment and with the help of the drawing, the figures of which show as follows:

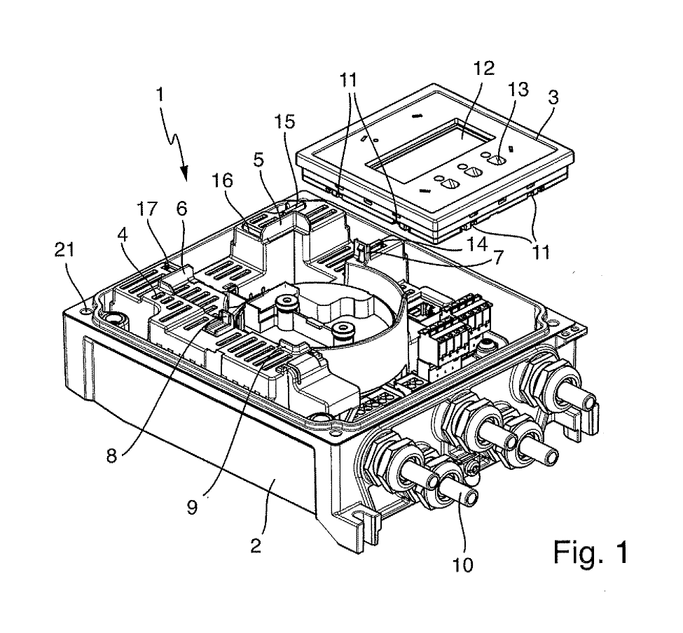

FIG. 1 perspective representation of a transmitter of the invention;

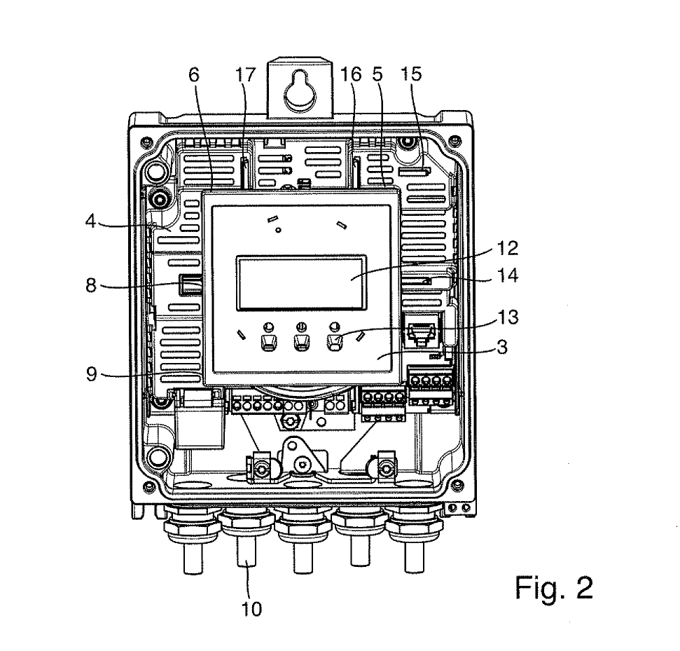

FIG. 2 front view of the transmitter with a display in park position A;

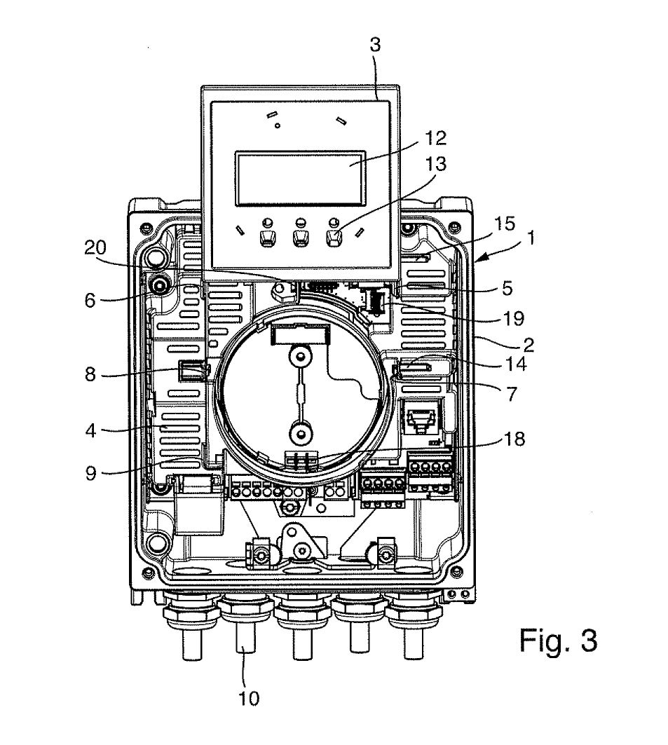

FIG. 3 front view of the transmitter with the display in park position B;

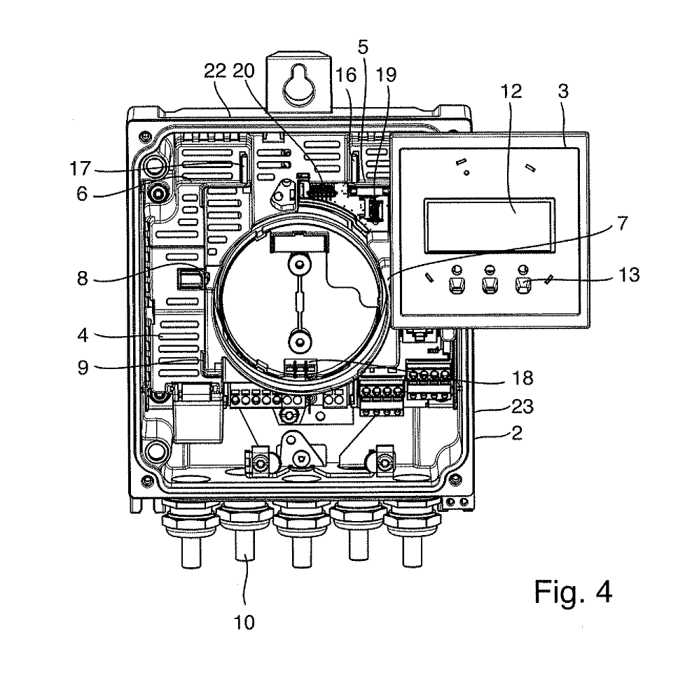

FIG. 4 front view of the transmitter with the display in park position C;

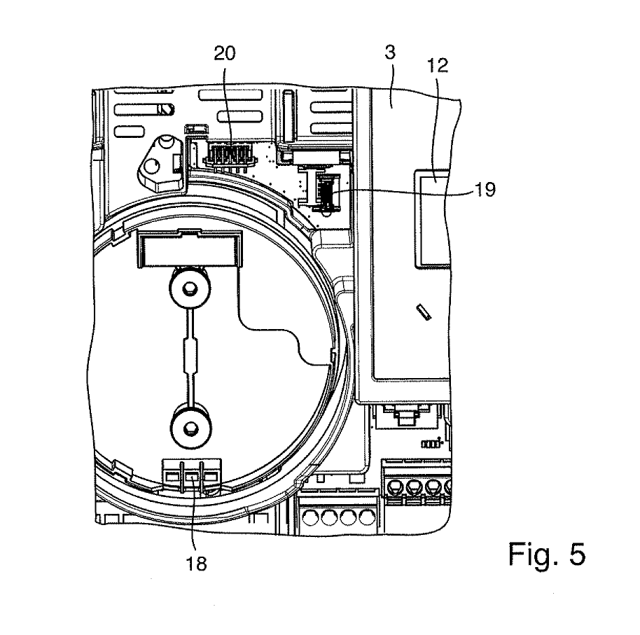

FIG. 5 detail view of the transmitter in park position C;

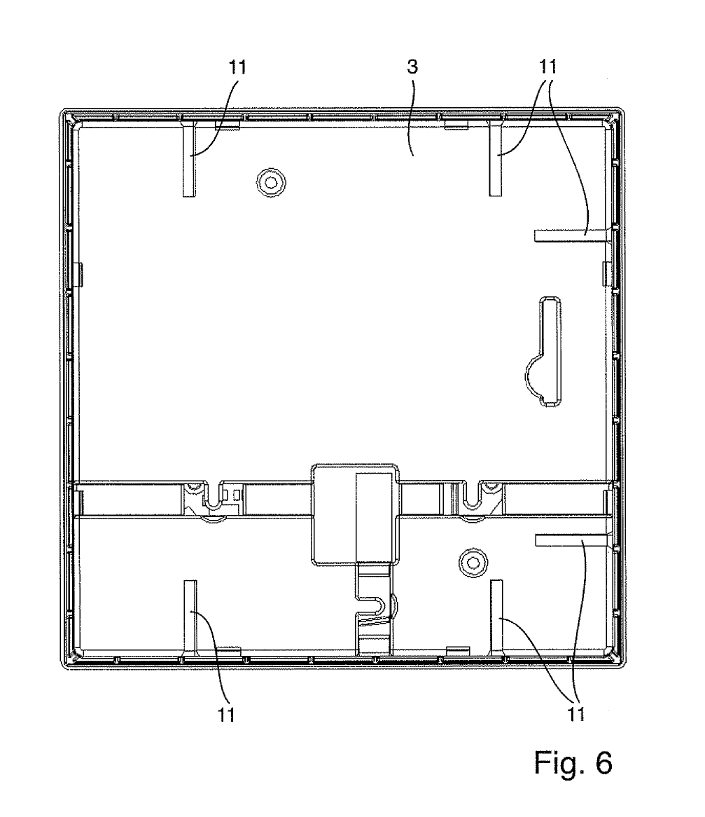

FIG. 6 rear view of the display of the transmitter; and

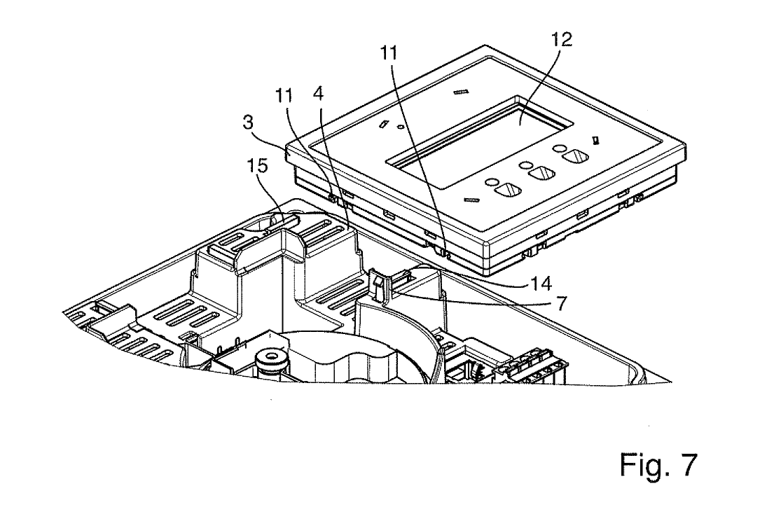

FIG. 7 detail view of the display and a transmitter housing of the transmitter.

In automation technology, especially in process automation technology, field devices are often applied, which serve for registering and/or influencing process variables. Serving for registering process variables are sensors, which are integrated, for example, in fill level measuring devices, flow measuring devices, pressure- and temperature measuring devices, pH-redox potential measuring devices, conductivity measuring devices, etc., which register the corresponding process variables, fill level, flow, pressure, temperature, pH-value, and conductivity, respectively. Serving for influencing process variables are actuators, such as, for example, valves or pumps, via which the flow of a liquid in a pipeline section, respectively the fill level in a container, can be changed. Referred to as field devices are, in principle, all devices, which are applied near to the process and deliver or process information relevant to the process. Understood in connection with the invention to be field devices are, thus, also remote I/Os, radio adapters, and, generally, electronic components, which are arranged at the field level. A large number of such field devices are produced and sold by the firm, Endress+Hauser.

A field device is, in such case, especially selected from the group composed of flow measuring devices, fill level measuring devices, pressure measuring devices, temperature measuring devices, limit level measuring devices and/or analytical measuring devices.

Flow measuring devices include especially Coriolis-, ultrasound-, vortex-, thermal and/or magneto inductive, flow measuring devices.

Fill level measuring devices include, especially, microwave fill level measuring devices, ultrasound fill level measuring devices, time domain reflectometric fill level measuring devices (TDR), radiometric fill level measuring devices, capacitive fill level measuring devices, inductive fill level measuring devices and/or temperature sensitive fill level measuring devices.

Pressure measuring devices include especially absolute-, relative- and difference, pressure measuring devices.

Temperature measuring devices include especially measuring devices with thermocouples and temperature dependent resistors.

Limit level measuring devices include especially ultrasound-limit level measuring devices and/or capacitive limit level measuring devices.

Analytical measuring devices include especially pH-sensors, conductivity sensors, oxygen- and active oxygen sensors, (spectro)-photometric sensors, and/or ion-selective electrodes.

The aforementioned field devices often make use, in such case, of a sensor, the so-called measuring transducer, and a transmitter, the so-called measurement transmitter.

FIG. 1 shows a transmitter 1 with a transmitter housing 2, in which the evaluating electronics of a field device is arranged. Only the lower shell of the transmitter housing is shown in FIG. 1. The housing does, however, also employ a housing lid, which has a cutout for a display 3. The lid (not shown in FIG. 1) can be connected with the housing lower shell with screws or other means in the region of the corner segments 21 of the transmitter housing 2.

Arranged within the transmitter housing 2 is a holding apparatus 4, which enables anchoring and positioning of individual electronic components within the transmitter housing 2. The holding apparatus 4 includes lateral stops 7, and angular stop pieces 5, 6 and 9, which protrude a few millimeters from the holding apparatus 4 toward the housing lid (not shown).

The transmitter 1 includes a number of cables 10 for signal transmission of a measurement signal ascertained by the field device and for energy supply of the field device. Cables 10 extend away from the transmitter housing 2.

The lateral stops 7 and 8 and the angular stop pieces 5, 6 and 9 serve for positioning the display 3 on the holding apparatus 4. The display 3 is thus, plugged onto the holding apparatus and held in a standard operation position A. Display 3 remains in this position on the holding apparatus 4 during standard operation.

The holding apparatus includes, moreover, plug projections 14-17, which likewise protrude from the holding apparatus 4 toward the housing lid a few millimeters. The function of the plug projections is explained in greater detail with reference to FIGS. 3-7.

In an embodiment, the field device, as a so-called two-conductor field device, has, in manner known per se, a so-called 4-20 mA electrical current output. In order to enable an auditable verification of the transmitter electronics, the transmitter 1 has an electronics connector 18, to which an external measuring device can be connected for the read-out of electrical current values. This electronics connector 18 is hidden by the display, when the display is located in the standard operation position A.

The display 3 includes a display unit 12 and a number of input and interaction elements 13 for interacting with the display unit 12. For exchange of information with other electronic components of the transmitter or, in given cases, directly with a sensor (not illustrated in greater detail) of the field device, the holding apparatus 4 includes a connector 19 for a display cable. For reasons of perspicuity, connector 19 is not shown in greater detail in FIGS. 1-7. It connects the display 3 with other electronic components within the transmitter housing 2.

Further arranged within the transmitter housing 2 is a data transfer connector 20. The field device can have, for example, at the interface between the sensor and the transmitter 1, a data memory, which manages data relative to the transmitter, process information, state of the device and/or a device history. This data can be read-out. Data can also be input to the data memory. As evident from FIGS. 1-7, also this data transfer connector 20 is at least partially covered by the display 3.

In order to enable access to the electronics connector and the data transfer connector for the connection of external measuring devices, computational units or data memory, a position change of the display 3 on the transmitter housing 2 can occur.

To this end, coupling elements are provided in FIGS. 1-7 in the form of plug connection elements 11, 14-17, which enable a positioning of the display at different positions on the holding apparatus 4. The plug connector element 11 is, in such case, a plug element receiver and the plug connection elements 14-17 are plug projections. Of course, a complementary embodiment likewise provides an option. Alternatively or supplementally, also corresponding coupling elements can be placed on the transmitter housing 2. In each position, the display is mechanically secured on the transmitter.

FIG. 2 shows the display 3 in the standard operation position A. In this position, the transmitter 1, or, more exactly stated, the transmitter housing 2, can be closed by means of the transmitter housing lid (not shown), without the display protruding out beyond the dimensions of the transmitter housing.

In the standard operation position A shown in FIG. 2, the display 3 is arranged centrally in the transmitter housing 2. This standard operation position is especially advantageous in the case of very small dimensioned transmitters, since then space is optimally utilized. Just the space requirement for repositioning the display would not justify a transmitter housing 2 of greater dimensions.

FIG. 3 shows the display 3 arranged in a park position B in the transmitter housing 2. In such case, the display 3 protrudes laterally over a first bounding wall section 22 of the transmitter housing 2. For better reference, a plane is defined by the four corner segments of the transmitter housing 21. All four corner segments lie, thus, on such plane. For repositioning of the display 3, such is lifted from the transmitter housing in a direction perpendicular to such plane. Then, the display is pushed in a direction parallel to such plane onto the plug connection elements 16 and 17. Thus, one or more plug projections illustrated in FIG. 2 engage in a groove shaped coupling element 11 provided on the rear side of the display 3.

In the park position B, the transmitter housing of FIG. 3 is not closable by means of a transmitter lid, due to the projection of the display 3. In this position, however, connectors are exposed, which serve for monitoring and checking the device. Thus, for example, via the electronics connector 18, the electrical current output of the transmitter in the range 4-20 mA is measurable e.g. by means of an additional electrical current measuring device. This park position makes it possible to read the measured values from the additional measuring device and to compare the reference value on the display 3. For this reason, the display with the display element 12 is arranged in such a manner that, indeed, a translational shifting of the display 3 occurs, but there is no rotation thereof.

FIG. 4 shows a park position C of the display 3 on the transmitter housing 2. In such case, the display 3 protrudes over a second bounding wall section 23 of the transmitter housing 2. This second bounding wall section 23 is perpendicular to the first bounding wall section 22. This position provides especially good accessibility to the data transfer connector 20. Display 3 is connected with the transmitter 1 via a display cable (not shown) and via a display cable connector 19.

FIG. 5 is a detail view of the data transfer connector 20, the connector 19 for the display cable and the electronics connector 18. One can see that the positioning of the display 3 in park position C provides an especially good accessibility to these connectors.

Moreover, the transmitter includes a central computing unit 24, which handles, coordinates, the computing tasks for processing the measurement data and other functions of the transmitter components. This central computing unit 24 is connected with the connector 25 via a cable covered in FIG. 5. Connectable to this connector 25 is a measurement amplifier, an input/output unit and/or a modem.

FIG. 6 shows the rear-side of a display. The rear-side of the display 3 is generally flat and bears the mentioned groove shaped plug connection elements 11. They extend, in each case, pairwise to at least one side wall of the display 3, in FIG. 6, however, actually to three side walls of the display 3.

FIG. 7 shows, in detail, how the coupling of the display occurs in the park position C. The groove shaped plug projections are embodied with L-shape, so that the groove extends from the rear-side of the display toward the display toward. Correspondingly, the plug projections 14-17 are embodied with L-shape on the holding apparatus, so that the two plug connection elements 14-17 and 11 engage and hold when the groove shaped plug element receivers 11 and the plug projections 14-17 are pushed together.

In the field device of the invention, usually the sensor produces an analog measurement signal. In the case of a magneto inductive flow measuring device, this is, for example, a voltage value. This is then converted into a digital value to provide a first output signal. This is output via an output unit, for example, the display. The digital value can additionally be changed back to an analog value and processed by means of pulse width modulation. Finally, the analog value is output as second output signal in the form of the electrical current output of preferably 4-20 mA.

In the case of the reconversion of the digital value into an analog value, the value can be corrupted. Therefore, a verification of the analog values in the field device is desirable, in order to check the reconversion.

By means of a preferred variant of the field device, a method for verification of the electrical current output signal is implementable.

This method includes preferably steps as follows:

A providing a field device, especially a field device as claimed in one of claims 1-9;
B removing an output apparatus, especially a display, from a predetermined accommodation in the field device, in which accommodation the output apparatus is arranged in a first position in a standard operation mode;
C mechanically coupling the output apparatus on the or in the transmitter by means of plug projections, especially plug connection elements, at a second position to expose an electronics connector for verification of an electrical current output signal; and
D connecting a measuring device for the read-out of the electrical current output signal on the electronics connector.

In given cases, a visual comparison can be made between the first output signal shown on the output apparatus and the second output signal, the electrical current output signal.

An advantage, in such case, is that the output apparatus can during the read-out of the electrical current output signal display in the second position furthermore an output value as reference value.

### LIST OF REFERENCE CHARACTERS

1 transmitter
2 transmitter housing
3 display
4 holding plate
5 angular stop pieces
6 angular stop pieces
7 lateral stop
8 lateral stop
9 angular stop pieces
10 electrical current output
11 plug element receiver
12 display element
13 input and interaction element
14 plug projection
15 plug projection
16 plug projection
17 plug projection
18 electronics connector
19 display cable
20 data transfer connector
21 corner segments
22 wall section
23 wall section
L longitudinal axis of the display

1-9. (canceled)

10. A field device comprising:
a sensor for ascertaining a measurement signal; and
a transmitter for converting the measurement signal into a first output signal;
an output unit is arranged in or on said transmitter for output of the first output signal, wherein:
said transmitter has two or more positioning locations for said output unit.

11. The field device as claimed in claim 10, the transmitter has in the region of one of the positioning locations one or more coupling elements, on or in which the output unit is releasably positionable.

12. The field device as claimed in claim 11, the coupling elements are plug connection elements.

13. The field device as claimed in claim 10, wherein:
the field device has at least two operating modes;
a first operating mode assures a standard operation and a second operating mode enables as a verification mode verification of conversion by said transmitter of the measurement signal into a second output signal;
for performing the verification mode an electronics connector is provided, whose accessibility is difficult in the standard operation and whose accessibility is facilitated in the verification mode;
the output unit for performing the standard operation mode is positionable in or on a first positioning location of the positioning locations; and
the output unit for performing the verification mode is positionable in or on a second positioning location.

14. The field device as claimed in claim 13, wherein:
said electronics connector is a 4-20 mA electrical current output.

15. The field device as claimed in claim 10, wherein:
said output unit is embodied as a display for displaying at least one row of characters or numbers and a longitudinal axis extends centrally through the row of said character or numbers;
this longitudinal axis of said display extends at a first positioning location parallel to the longitudinal axis of the display device at a second positioning location.

16. The field device as claimed in claim 15, wherein:
the longitudinal axis of said display at a first positioning location extends parallel to the longitudinal axis (A) of the display at all additional positioning locations.

17. The field device as claimed in claim 10, wherein:
the field device has at least two operating modes;
one operating mode assures a standard operation and one operating mode enables a feeding of data into or a reading of data out of a memory unit of the field device;
for performing the feeding-in or reading-out of the data, a data transfer connector is provided, whose accessibility is difficult in standard operation and whose accessibility is facilitated in the verification mode;
the output unit for performing the standard operation mode is positionable in or on a first positioning location of the positioning locations; and
said output unit for performing the feeding-in or reading-out of the data is positionable in or on a second positioning location of the positioning locations.

18. The field device as claimed in claim 10, wherein:
said output unit displays an output signal during the feeding-in or reading-out of data and/or during the verification mode.
